(19) United States
(12) Patent Application Publication
(10) Pub. No.: US 2011/0304474 A1
(43) Pub. Date: Dec. 15, 2011

(54) Compact Wireless Transceiver

(75) Inventors: Philippe Salamitou, Paris (FR); Benoit Schmitt, Massy (FR)

(73) Assignee: Schlumberger Technology Corporation, Sugar Land, TX (US)

(21) Appl. No.: 13/143,042

(22) PCT Filed: Dec. 17, 2009
(86) PCT No.: PCT/EP2009/009119

§ 371 Date: Aug. 24, 2011

(30) Foreign Application Priority Data
Dec. 30, 2008 (EP) 08291254.4

(51) Int. Cl. G01V 3/00

(52) U.S. Cl. 340/854.6

(57) ABSTRACT

A communication device for an electromagnetic telemetry system for use in a well is adapted to be attached to a conductive pipe of the well and includes at least one transmitter unit for emitting a modulated electrical current in the pipe and at least one receiver unit for receiving the modulated electrical current transmitted in the pipe, the transmitter unit and the receiver unit each comprising an antenna with a magnetic core and a winding around the magnetic core, wherein the antenna is oriented such that the magnetic moment of the winding is tangential to the cross-section of the pipe for respectively emitting and receiving the modulated electrical current.

### BACKGROUND OF INVENTION

1. Field of the Invention

The invention relates generally to telemetry system and particularly to a wireless communication device used in a wellbore to communicate information between equipment at the surface and downhole equipment positioned in the wellbore.

2. Background Art

Electromagnetic telemetry is used in oil or gas wells during drilling, testing, or production to communicate information between a downhole location and the surface. The information is conveyed by electromagnetic waves that are modulated accordingly, whereby the waves may propagate through the earth, the casing of the well, or a fluid in a pipe. Three examples of implementing wireless electromagnetic telemetry are presented in the following.

Document U.S. Pat. No. 5,396,232 describes one technique that consists in introducing an electrically non conductive section along the pipe, and to apply a voltage across this gap. An electrical signal is then measured on the surface in the form of a voltage difference across two points on the ground. This technique creates a mechanical weak point in the pipe, and it is difficult to implement for drill pipes, well casing, or well tubing. Indeed, these pipes are typically made of solid steel and are associated with stringent mechanical requirements. It is difficult to realize an isolating section while maintaining the mechanical quality of solid steel pipes.

Another technique, as described in document U.S. Pat. No. 4,839,644, consists in replacing the isolated section in the pipe by a magnetic toroid. The toroid creates a self inductance on the pipe, which acts as isolating gap for AC electrical currents. In this technique, a winding around the toroid behaves as the primary coil of a transformer, and the secondary coil is the pipe itself The electrical current signal is generated in the pipe by applying a voltage across the winding. The electrical signal in the pipe is detected by reading the voltage created at the winding by AC current in the pipe. This technique does not require a mechanical discontinuity in the pipe, leaving its mechanical properties intact. It has nonetheless limitations related to fabrication and deployment cost. Indeed, well pipes have varying dimensions and characteristics that are specific to individual wells. It is therefore difficult to design and fabricate a generic toroid-based system that is compatible with different wells. As a consequence, toroid systems are custom made, which induces important logistics and manufacturing costs. Furthermore, the toroidal shape is difficult to package and to protect from aggressive environmental conditions that are inherent to oil or gas wells.

The objective of the present invention is to overcome limitations of current techniques and to provide a robust, compact wireless telemetry transmitter and/or receiver design, which can be easily deployed and fitted onto various pipes, without significant customization-specific requirements.

### SUMMARY OF INVENTION

In a first aspect, embodiments disclosed herein relate to a communication device for an electromagnetic telemetry system for use in a well, the communication device being adapted to be attached to a conductive pipe of the well. The device comprises at least one transmitter unit for emitting a modulated electrical current in the pipe and at least one receiver unit for receiving the modulated electrical current transmitted in the pipe. The transmitter unit and the receiver unit each comprise an antenna with a magnetic core and a winding around the magnetic core, wherein the antenna is oriented such that the magnetic moment of the winding is tangential to the cross-section of the pipe for respectively emitting and receiving the modulated electrical current.

In a second aspect, embodiments disclosed herein relate to a wireless electromagnetic telemetry system for use in a well. The system comprises a surface platform located at a surface location, at least one wireless gateway linked to the surface platform, and a communication device according to the first aspect. The wireless gateway is connected to the transmitter unit, the receiver unit or the transceiver unit.

In a third aspect, embodiments disclosed herein relate to a method for communicating signals in a telemetry system in a well using a communication device being adapted to be attached to a conductive pipe. The device comprises at least one transmitter unit and at least one receiver unit, and the transmitter unit and the receiver unit each comprise an antenna with a magnetic core and a winding around the magnetic core. The method comprises placing the communication device such that the magnetic moment of the winding of the antenna is tangential to the cross-section of the pipe, emitting a modulated electrical current in the pipe by applying a modulated electrical signal to the antenna of the transmitter unit, thereby generating a magnetic field, and receiving an electrical signal by detecting the modulated electrical current transmitted in the pipe using the antenna of the receiver unit.

In a further aspect, there is provided a communications device for mounting on a conductive pipe, the communications device comprising: at least one of a transmitter for transmitting an electrical signal along the pipe and a receiver for receiving an electrical signal transmitted along the pipe, the at least one transmitter and receiver comprising a magnetic core and a winding around the core, and wherein the magnetic core having an elongated shape with an orientation that is located substantially parallel to an elongated orientation of the pipe.

The magnetic core and winding are enclosed in a cylindrical housing located on the pipe at an orientation that is substantially parallel to the pipe.

Other characteristics and advantages of the invention will be apparent from the following detailed description and the appended claims.

### BRIEF DESCRIPTION OF DRAWINGS

FIG. 1 shows a schematic view of a transmitter/receiver unit of a communication device in accordance with embodiments disclosed herein.

FIG. 1a shows a schematic view of an antenna of the communication device in accordance with embodiments disclosed herein.

FIGS. 2a-2c schematically show the orientation of the antenna with respect to a pipe during use in accordance with embodiments disclosed herein.

FIG. 3 schematically shows transmitter and receiver electronics means of the communication device in accordance with embodiments disclosed herein.

FIG. 4 shows a cross-section of the communication device in accordance with embodiments disclosed herein.

FIGS. 5a and 5b schematically show examples of mounting the transmitter/receiver unit onto the pipe.

FIG. 6 shows a schematic view of a wireless electromagnetic telemetry system in accordance with an embodiment disclosed herein.

FIG. 7 shows a schematic view of a wireless electromagnetic telemetry system in accordance with another embodiment disclosed herein.

### DETAILED DESCRIPTION

Specific embodiments of the electromagnetic telemetry system disclosed herein will now be described in detail with reference to the accompanying figures. Like elements in the various figures may be denoted by like reference numerals for consistency.

In a first aspect, embodiments disclosed herein provide a communication device for a wireless electromagnetic telemetry system for communicating signals between a location on the surface of the ground and a downhole location.

The communication device according to embodiments disclosed herein is for use in an electromagnetic telemetry system deployed in a well. The communication device is adapted to be attached to a conductive pipe such as those used to drill, construct, and complete hydrocarbon wells. The pipe may be a drill pipe, a casing, a running tool, a drill stem, a tubing, a liner, a sand screen, etc. The communication device includes a transmitter unit and a receiver unit. The device may thereby include two units (one for transmitting and one for receiving information) or one unit only (a transceiver unit for both transmitting and receiving information). In the following, when referring to either of these cases, we will use the term “transmitter/receiver unit”.

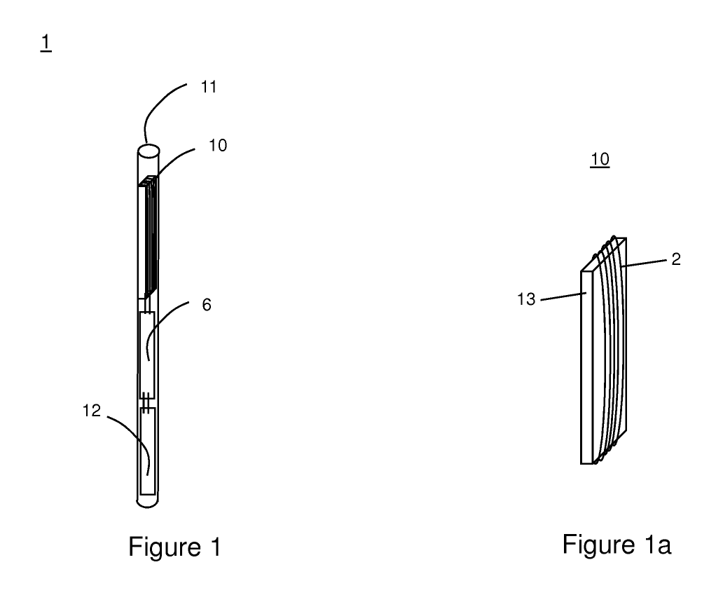

FIG. 1 shows the transmitter/receiver unit 1 of the communication device according to an embodiment disclosed herein. The transmitter/receiver unit 1 includes an antenna 10, electronics means 6, and a power source 12. Furthermore, transmitter/receiver unit 1 includes a housing 11 in which all the other components are arranged.

As shown in FIG. 1 a, the antenna 10 includes a magnetic core 13 and a winding 2 around the magnetic core 13. The antenna 10 has an elongated shape, but, as the skilled person will appreciate, the antenna 10 may take other shapes as the one shown in FIG. 1a.

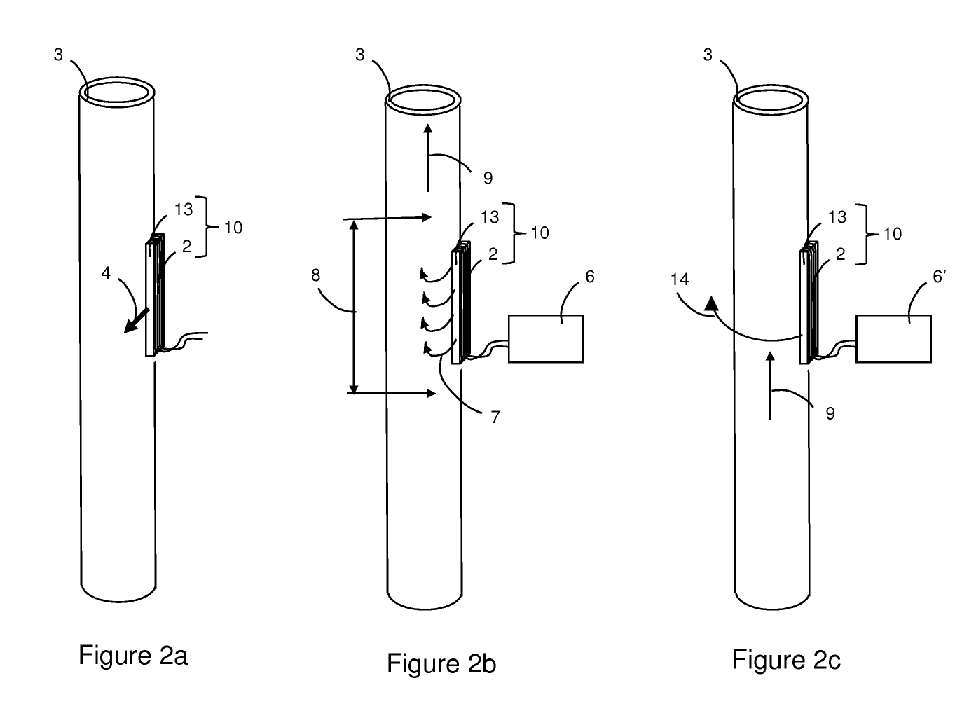

FIGS. 2a to 2c show the orientation and the operation principle of the antenna 10 in the transmitter/receiver unit (not shown) with respect to the pipe 3. As shown in the embodiment of FIG. 2a, the antenna 10 is oriented such that the magnetic moment 4 of the winding 2 of the antenna is tangential to the cross-section of the pipe 3. The magnetic core 13 and the winding 2 may be enclosed in a cylindrical housing located on the pipe 3 at an orientation that is substantially parallel to the pipe 3.

Referring now to FIG. 2b, at emission, i.e., for sending information, transmitter electronics means 6 generate a modulated electrical current in the winding 2 of the antenna 10. This electrical current generates a magnetic field 7, which is partially coupled to the conductive pipe 3. In the pipe 3, the magnetic field 7 induces a modulated electrical current 9 which carries the information to be transmitted.

At reception, shown in FIG. 2c, the modulated electrical current 9 generates a magnetic field 14 tangential to the pipe cross-section. The magnetic field 14 creates a modulated electrical signal in the antenna 10, and a resulting voltage can be detected by the receiver electronics means 6′.

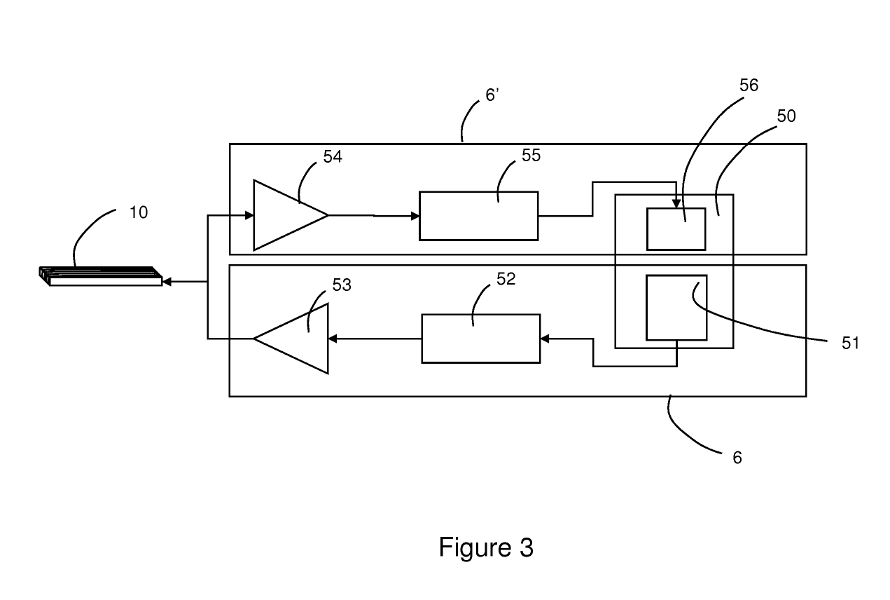

Referring to FIG. 3, the transmitter and receiver electronics means 6, 6′ of the communication device according to embodiments disclosed herein are described in more detail. The transmitter electronics means 6 include a modulator 51, a digital-to-analog converter (DAC) 52, and an output driver 53. The modulator 51 modulates a digital electrical signal so as to generate a modulated digital signal carrying the information to be transmitted. The DAC 52 then converts the modulated digital signal into a modulated analog signal (the modulated electrical current), which is delivered to the antenna 10 by the output driver 53.

The receiver electronics means 6′ include a signal amplifier 54, an analog-to-digital converter (ADC) 55, and a demodulator 56. The modulated electrical current induced in the antenna 10 generates an analog antenna signal that is buffered, filtered, and amplified by the signal amplifier 54. The analog signal is then converted by the ADC 55 into a digital antenna signal, which is demodulated by the demodulator 56 to obtain the transmitted information by generating a demodulated digital antenna signal.

The modulation of the digital electrical signal may be realized by modulating the phase, the amplitude, or the frequency of the signal. The signal frequency is typically between around 10 Hz and 1 kHz. The lower frequency range limit is determined by the diminishing efficiency of the induction with decreasing signal frequency. The upper frequency range limit is chosen so as to avoid the skin effect in the pipe which increases signal attenuation with increasing signal frequency. Advanced signal processing techniques, developed for telecommunication applications, such as equalizer filters and turbo coding may be used to improve the robustness of the modulation and demodulation processes against data-corrupting noise and signal distortion.

In the specific embodiment of FIG. 3, the transmitter and receiver electronics means 6, 6′ address the same antenna 10. They also share the same control unit 50. Thus, a transceiver unit is provided, which is adapted to manage half-duplex communication according to embodiments disclosed herein.

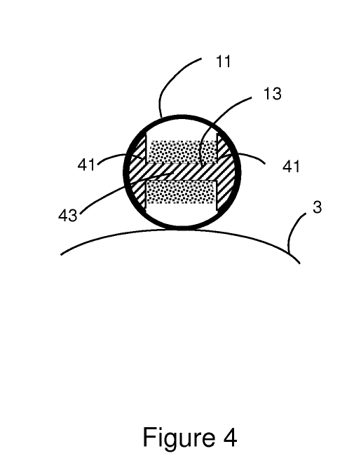

Referring now to FIG. 4, a cross-section of the communication device in a preferred embodiment, attached to the pipe 3, is shown. The magnetic core 13 of the antenna inside the housing 11 has a specific cross-section showing two flanges 41 connected by a bar 43. This design allows diminishing the reluctance of the magnetic circuit associated with the antenna.

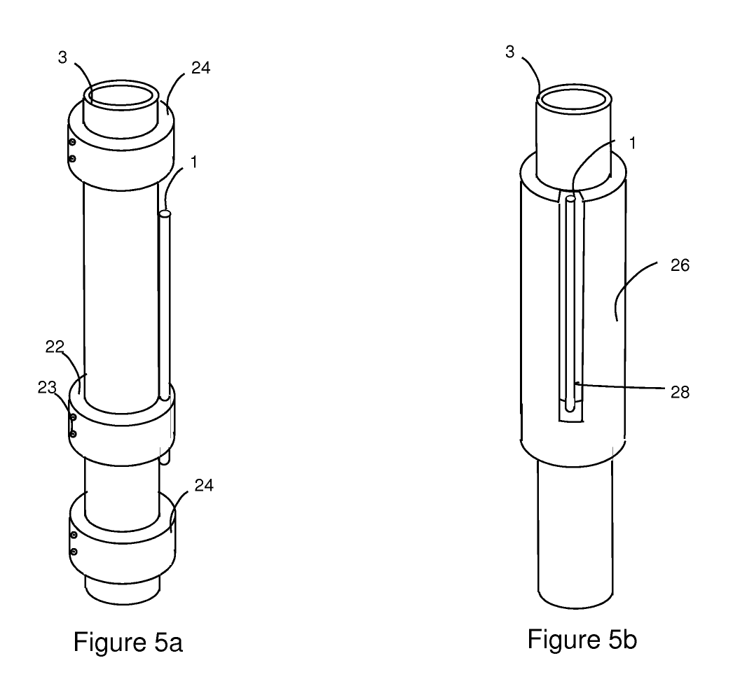

FIGS. 5a and 5b schematically show two examples of mounting the transmitter/receiver unit 1 onto the pipe 3. In FIG. 5a, the transmitter/receiver unit 1 is attached to the pipe 3 using a clamp 22. The clamp 22 itself may be fastened to the pipe 3 using screws 23 or the like, and it may be made of a magnetic material in order to improve the magnetic coupling between the antenna in the transmitter/receiver unit 1 and the pipe 3. In this embodiment, further clamps 24 are installed above and beneath the transmitter/receiver unit 1 on the pipe 3 in order to protect the transmitter/receiver unit 1 from shocks, which may occur during deployment of the communication device.

In the embodiment shown in FIG. 5b, the transmitter/receiver unit 1 is attached to the pipe by way of a mandrel 26. The transmitter/receiver unit 1 is maintained in the mandrel, for example, by having a groove 28 in which the transmitter/receiver device 1 is inserted and attached by bolts (not shown). In one embodiment, the mandrel 26 is fastened to the pipe 3. In another embodiment, the mandrel is molded from material integral with the pipe. In a further embodiment, the totality or parts of the mandrel 26 may be made of a magnetic material in order to improve the magnetic coupling between the antenna in the transmitter/receiver unit 1 and the pipe 3.

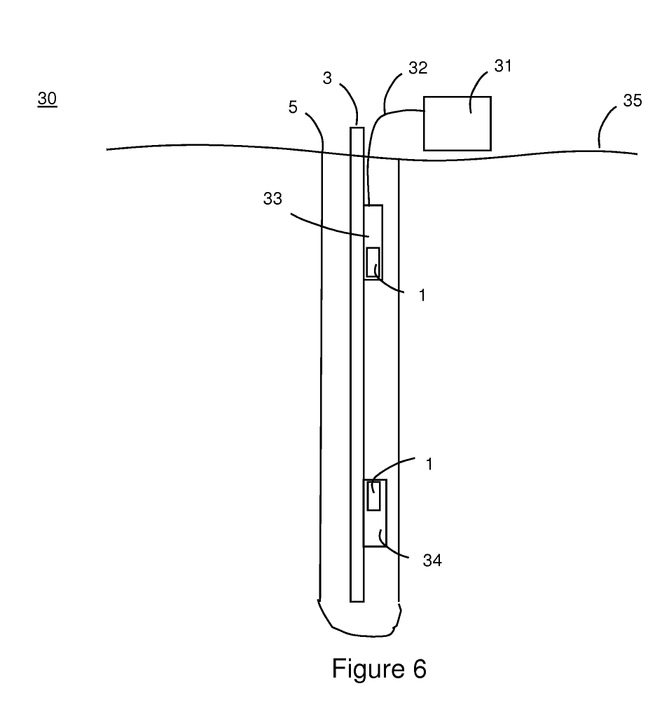

In a second aspect, embodiments disclosed herein relate to a wireless electromagnetic telemetry system 30 used in a well 5, as shown schematically in FIG. 6. The system 30 includes a surface platform 31 that is installed at the surface 35 of the ground and that is connected to a gateway 33 by cable 32. The gateway 33 may have, for example, a wired or fixed connection by cable 32 to the surface and may contain electronics which enable the wireless signals received from the wireless transmitter/receiver unit to be converted into fixed signals that are to be transferred over the physical cable 32 to the surface platform 31. The gateway 33 is located in the well 5 and thus provides a transition between the wired telemetry system represented by cable 32 and the wireless telemetry system represented by the pipe 3. The system further includes downhole equipment 34 in the well 5. The gateway 33 and the downhole equipment 34 are each associated with one transmitter/receiver unit 1 of the communication device according to embodiments disclosed herein. The gateway 33 and the downhole equipment 34 may also include other transmitter/receiver devices that are adapted to operate with the telemetry signal (the current in the pipe) that is emitted and/or received by the transmitter/receiver units 1. The other transmitter/receiver devices may, for example, include the ones described in the Background Art section.

According to custom-specific requirements, the gateway 33 may be located at the surface 35, below the surface 35 at shallow depth in the well 5, or downhole close to the downhole equipment 34. The person skilled in the art will appreciate that the location of the gateway 33 with respect to the surface 35 depends on several aspects. Specifically, the depth until which it is more advantageous to run a cable 32 than to use wireless telemetry may vary for different sites or formations. It is notably advantageous to replace a wired telemetry system by a wireless telemetry system in instances where the cable 32 cannot be deployed in one run because the hosting pipe 3 presents discontinuities. This is the case, for example, if the downhole equipment 34 is attached to a lower completion which is installed after the upper completion. In this scenario, the gateway 33 may be installed at the bottom of the upper completion and communicate wirelessly to the downhole equipment 34 located in the lower completion. The distance between the gateway 33 and the downhole equipment 34 in this simple deployment scheme is smaller than the maximum range of the telemetry signal. Information (measuring data, control commands, etc.) may then be communicated between the wireless gateway 33 and the downhole equipment 34 (such as downhole measuring tools) through the communication device.

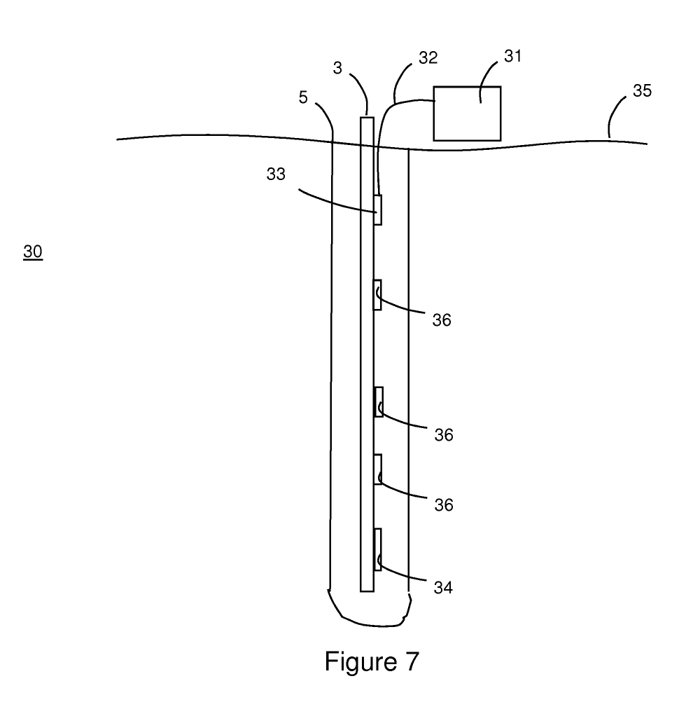

Referring now to FIG. 7, a schematic view of the wireless telemetry system 30 according to a preferred embodiment is shown. The system 30 includes a linear array 36 of transmitter/receiver units. The array 36 is deployed along the well 5 so that the distance between the different transmitter/receiver units is smaller than the maximum range of the telemetry signal. The uppermost transmitter/receiver unit, which is located most shallow beneath the surface 35 in the well 5, is linked to the wireless gateway 33, and the bottom transmitter/receiver unit is linked to the downhole equipment 34. Information is communicated between the gateway 33 and the downhole equipment 34 through the communication device, the information being relayed by the successive transmitter/receiver units 36.

Typically, the maximum range of the telemetry signal that is generated by the transmitter units is of the order of a few 100 m. The signal range can be increased by increasing the output power of the transmitter unit.

The power source 12 of the transmitter/receiver unit 1 as schematically shown in FIG. 1 may be battery cell enclosed in the housing 11 of the transmitter/receiver unit 1. If the transmitter/receiver unit 1 is connected with a gateway or with downhole equipment such as a downhole tool, it may draw its driving power from the gateway or the downhole tool.

As shown in FIG. 1 or 2, the antenna 10 has an elongated shape that allows for a packaging, i.e., a housing 11 having a small cross-sectional area. The cross-section of the housing 11 may be circular so as to provide a cylindrical housing that is adapted to withstand high environmental pressures, which are typical in oil or gas wells. The housing 11 further provides a robust atmospheric chamber that protects the antenna 10 and the electronics means in the transmitter/receiver unit from the downhole environment. The housing 11 may be made of non magnetic stainless steel or any other appropriate material. Furthermore, by optimising the antenna winding 2, the electrical power loss resulting from eddy currents in the housing 11 can be made minimal. For example, the winding 2 may be made of enamelled copper wire with a diameter around 200 μm, and a number of turns around 1000. With these characteristics, the eddy current losses in the housing 11 are negligible.

Embodiments of the present invention may further include one or more of the following advantages. Due to the compact packaging of the transmitter/receiver units, the communication device may be deployed in numerous well bore geometries as well as in various applications that are targeted by electromagnetic telemetry schemes. For example, the communication device may be deployed on a drill stem to convey well test information, or it may be deployed on a drill string to convey formation evaluation information along the drill string. Further, the communication device may be deployed on well casing to convey information regarding production such as formation pressure and water saturation. It may also be placed on production tubing, liner or sand screens to convey production information such as well bore pressure and flow rates. The communication device may thereby be permanently installed or deployed temporarily. Therefore, the device may respond to a wide range of customer-specific requirements.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1-22. (canceled)

23. A communication device for an electromagnetic telemetry system for use in a wellbore, the communication device being adapted to be attached to a pipe in the well, the device comprising:
at least one transmitter unit emitting a modulated electrical current in the pipe; and
at least one receiver unit for receiving the modulated electrical current transmitted in the pipe, the at least one transmitter unit and the at least one receiver unit each comprising an antenna with a magnetic core and a winding around the magnetic core, wherein the antenna is oriented such that the magnetic moment of the winding is tangential to the cross-section of the pipe a for respectively emitting or receiving the modulated electrical current.

24. The communication device of claim 23, wherein the magnetic core is of an elongated shape.

25. The communication device of claim 24, wherein the antenna is enclosed in a housing having a circular cross-section.

26. The communications device of claim 25, wherein at least one of the at least one transmitter unit and the at least one receiver unit is enclosed in the housing.

27. The communications device according to claim 25, wherein at least one of the at least one transmitter unit and at least one of the at least one receiver unit are enclosed in the housing.

28. The communication device of claim 23, wherein the at least one transmitter unit and the at least one receiver unit have a common antenna adapted for either emitting or receiving the modulated electrical current.

29. The communication device of claim 23, wherein the at least one transmitter unit comprises transmitter electronics means comprising:
a modulator for generating a modulated digital signal;
a digital-to-analog converter for generating a modulated analog signal; and
an output driver for delivering the modulated analog signal to the antenna.

30. The communication device of claim 23, wherein the at least one receiver unit comprises receiver electronics means comprising:
a signal amplifier for buffering, filtering, and amplifying an analog antenna signal;
an analog-to-digital converter for generating a digital antenna signal; and
a demodulator for generating a demodulated digital antenna signal.

31. The communication device according to claim 28, wherein the at least one transceiver unit comprises transceiver electronics means comprising:
a modulator for generating a modulated digital signal;
a digital-to-analog converter for generating a modulated analog signal;
an output driver for delivering the modulated analog signal to the antenna;
a signal amplifier for buffering, filtering, and amplifying an analog antenna signal;
an analog-to-digital converter for generating a digital antenna signal; and
a demodulator for generating a demodulated digital antenna signal.

32. The communication device of claim 23, wherein the modulated electrical current has a frequency range between ten Hertz and 1 kiloHertz.

33. The communication device of claim 25, wherein the housing is attached to the pipe by a clamp.

34. The communication device of claim 25 wherein the housing is inserted in a mandrel attached to the pipe.

35. The communication device of claim 25, wherein the housing is cylindrically shaped.

36. The communication device of claim 25, wherein the housing is made of non-magnetic stainless steel.

37. The communication device of claim 33, wherein the clamp is made of magnetic material.

38. The communication device of claim 34, wherein the mandrel is made of magnetic material.

39. The communication device of claim 23, comprising a linear array of the at least one transmitter unit and the at least one receiver unit.

40. An electromagnetic telemetry system for use in a well comprising:
a gateway linked to a surface platform by a cable; and
a communication device attached to a conductive pipe deployable in the well, wherein the gateway is connected to a transmitter unit or a receiver unit, wherein the transmitter unit emits a modulated electrical current in the pipe and further wherein the receiver unit receives electrical current in the conductive pipe.

41. The electromagnetic telemetry system of claim 40, wherein the gateway is capable of being located at a surface location, at shallow depth below the surface platform, or in the well.

42. The electromagnetic telemetry system of claim 40, the communication device comprising a linear array including the transmitter unit and the receiver unit in a gateway, and another transmitter unit or receiver unit of the linear array in downhole equipment in the well.

43. A method for communicating signals in a telemetry system in a well comprising:
deploying a communication device on a pipe having at least one transmitter unit and at least one receiver unit in the well, the transmitter unit and the receiver unit each comprising an antenna with a magnetic core and a winding around the magnetic core,
positioning the communication device such that the magnetic moment of the winding of the antenna is tangential to the cross-section of the pipe;
emitting a modulated electrical current in the pipe by applying a modulated electrical signal to the antenna of the transmitter unit, thereby generating a magnetic field; and
receiving an electrical signal by detecting the modulated electrical current transmitted in the pipe using the antenna of the receiver unit.
